(19) United States
(12) Patent Application Publication
(10) Pub. No.: US 2008/0018218 A1
(43) Pub. Date: Jan. 24, 2008

(54) Straddling and supporting structure for a field emission display device and a manufacturing method thereof

(76) Inventors: Wei-Sheng Hsu, Taipei (TW); Cheng-Chieh Kao, Taipei (TW); Yi-Jung Chung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/491,123

(22) Filed: Jul. 24, 2006

(51) Int. Cl. H01J 1/62; H01J 9/24; H01J 1/88

(52) U.S. Cl. 313/292; 313/495; 445/25; 445/24; 313/497

(57) ABSTRACT

A straddling and supporting structure for a field emission display device and a manufacturing method thereof is disclosed. The present invention provides a supporting structure that straddles across electrodes to provide a straddling structure for the conducting lines between the electrodes to shorten the conducting path, and can be used as a vacuum supporting structure between the cathode substrate and the anode substrate.

### BACKGROUND OF THE INVENTION

1. Field of the Invention

The present invention relates to a straddling and supporting structure for the field emission display device and a manufacturing method thereof. In particular, this invention relates to a straddling and supporting structure used between a cathode substrate and an anode substrate of the field emission display device to straddle and support the cathode conducting line and the anode conducting line.

2. Description of the Related Art

The field emission display (FED) device can be applied to a variety of apparatuses, such as the display screen on a telephone, the display screen on a car, an outdoor lighting apparatus, or a display for a traffic light, etc. Recently, because carbon-nano tubes used in emission device have improved their efficiency in generating electron beams, field emission display device have begun to use carbon-nano tubes. A carbon-nano tube is disposed on the electrode of the cathode conducting layer of the field emission display to form an electron emission source.

Because the efficiency of electron emission is high, it is sensitive to electric fields. Furthermore, the uniformity of the electric field of the display increases the uniformity of the generated image. Therefore, the structure of the electric field (such as the uniformity of the height of the rib supporting device, the resistance of the electrodes) is a key factor.

The rib supporting device is used for maintaining the vacuum between the cathode substrate and the anode substrate to prevent the cathode substrate and the anode substrate from being conducted via an external electric field. The electric field density is in direct proportional to the voltage of the cathode, the anode of the cathode substrate and the anode substrate, and the electric field density is inversely proportional to the gap between the cathode and the anode. The gap between the cathode and the anode is controlled by the ribs that are used as a supporting device. The uniformity of the height of the supporting device is a key factor for the lighting uniformity of the field emission display.

The anode absorbs the electrons emitted from the cathode electron emission source to agitate and light the fluorescent powder. Therefore, the cathode electrode, anode electrode, and the electrode conducting line with a low resistance and a high conducting efficiency are preferred. It prevents the lighting efficiency of the electric field from being lowered due to the resistance of the electrode material or the voltage drop. As the dimensions of the field emission display become larger, the length of the electrode conducting line becomes more complex and longer. For example, when the field emission display is used as a display screen in a car, the display patterns have to be disposed on a specified area. The independent conducting lines connected to each of the display units must be separated so as to remove the need for the electrode conducting lines to become more complex and longer. The problems of electric field and voltage drop caused by the resistance of the conducting lines, and current leakage or cross talk caused by the voltage drop between adjacent conducting lines are thereby avoided.

In order to overcome the problems of the conducting line being too long, and the cross talk produced between the adjacent conducting lines, the shortest path possible is obtained by directly connected with the electrodes via a straight line. There is no display area on the shortest path, and an insulating material covers the shortest path. Next, a new conducting line is built above the insulating material to directly conduct the two electrodes so as to shorten the conducting line. However, this method disposes the conducting lines in the vacuum element and the substrate is usually made of glass, the conducting line is fastened to the glass substrate via a screen-printing process and a high temperature burning process. Therefore, the thickness of the conducting line is 10 cm. Because the vacuum gap between the cathode and the anode is 50˜100 μm, the electrode structure becomes thicker and the gap becomes smaller. It is not good for passing a high voltage through the cathode and the anode, and it easily generates an arc between the cathode and the anode. Furthermore, because the insulating layer is spread on other conducting lines, the surface is not smooth. When a straddling conducting line is located on an uneven surface, the structure of the conducting line becomes worse and damaged.

### SUMMARY OF THE INVENTION

One particular aspect of the present invention is to provide a straddling and supporting structure for the field emission display device and a manufacturing method thereof. The present invention provides a straddling structure for the conducting lines between the electrodes to shorten the conducting path, and is used as a vacuum supporting structure between the cathode substrate and the anode substrate.

The straddling and supporting structure for the field emission display device includes a plurality of insulating layers, and a conducting layer. The insulating layers are stacked, and the conducting layer is located on one surface of the last insulating layer of the insulating layers and there is a concave groove on a surface of the conducting layer.

The manufacturing method of a straddling and supporting structure for the field emission display device includes (a) providing a substrate, (b) forming an insulating layer on the substrate via a printing method, (c) preheating a surface of the insulating layer via a first preheating process, (d) stacking a second insulating layer on the insulating layer via the printing method, (e) preheating a surface of the second insulating layer via the first preheating process, (f) repeating steps (d) and (e) until a plurality of insulating layers are formed, (g) stacking a conducting layer on the last insulating layer via the printing method, (h) preheating a surface of the conducting layer via a second preheating process, (i) forming a concave groove on the surface of the conducting layer via a mold-pressing method, (j) preheating the insulating layers and the conducting layer via a third preheating process, and (k) solidifying the insulating layers and the conducting layer via a burning process.

Via the supporting structure for field emission straddling electrodes manufactured by the above steps, and flexibly disposing the supporting and straddling location of the field emission display device, the supporting and straddling effect is achieved.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a flow chart of the manufacturing method for a straddling and supporting structure for the field emission display device of the present invention;

FIGS. 2A˜2F are perspective views of the manufacturing method for a straddling and supporting structure for the field emission display device of the present invention;

FIG. 3 is a perspective view of the straddling and supporting structure for the field emission display device of the first embodiment of the present invention;

FIG. 4 is a front view of the straddling and supporting structure for the field emission display device of the first embodiment of the present invention; and

FIG. 5 is a perspective view of the straddling and supporting structure for the field emission display device of the preferred embodiment of the present invention.

### DETAILED DESCRIPTION OF THE PREFERRED EMBODIMENTS

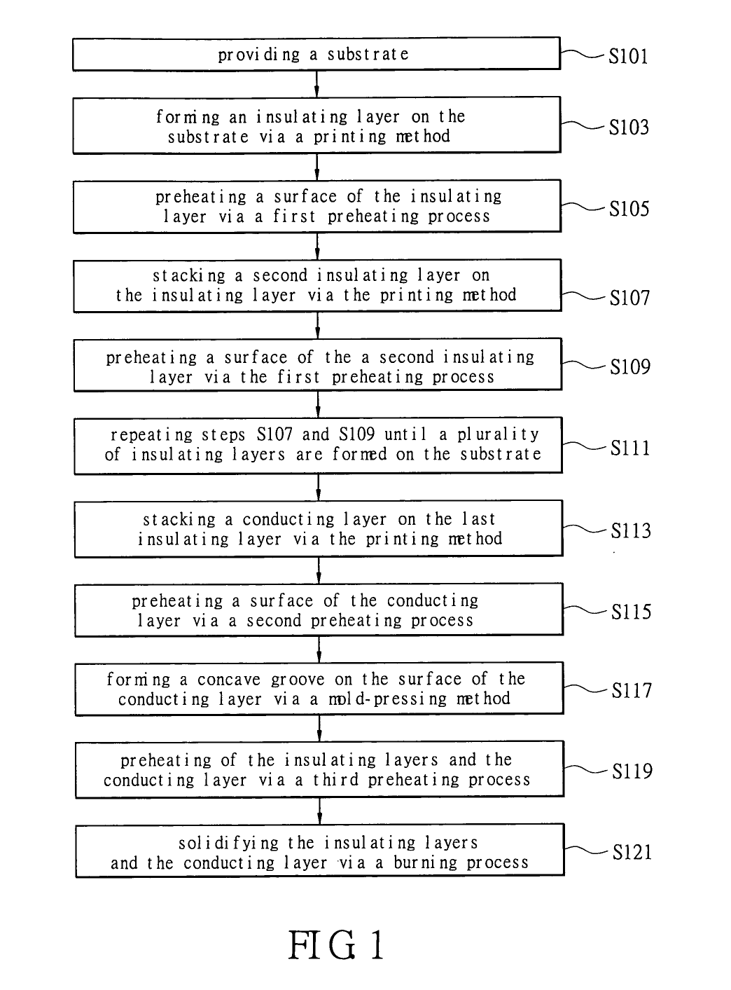

Reference is made to FIG. 1, which shows a flow chart of the manufacturing method for a straddling and supporting structure for the field emission display device of the present invention. The manufacturing method for a straddling and supporting structure of the present invention includes providing a substrate (S101), forming an insulating layer on the substrate via a printing method (S103), preheating a surface of the insulating layer via a first preheating process (S105), stacking a second insulating layer on the insulating layer via the printing method (S107), preheating a surface of the second insulating layer via the first preheating process (S109), repeating steps (S107) and (S109) until a plurality of insulating layers are formed on the substrate (S111), stacking a conducting layer on the last insulating layer via the printing method (S113), preheating a surface of the conducting layer via a second preheating process (S115), forming a concave groove on the surface of the conducting layer via a mold-pressing method (S117), preheating the insulating layers and the conducting layer via a third preheating process (S119), and solidifying the insulating layers and the conducting layer via a burning process (S121).

The first preheating process in S105 and S109 is a 100° C. preheating process and lasts 10 minutes. The first preheating process removes part of the printing liquid of the insulating layer and solidifies the printing material of the insulating layer to support the incoming printing process. The second preheating process in S115 is a 100° C. preheating process and lasts 2 minutes. The second preheating process removes part of the liquid on the surface of the printing material and makes the conducting layer more malleable for processing in S117. The mold-pressing method in S117 presses the surface of the conducting layer to form a concave groove. The depth of the concave groove corresponds to the thickness of the convex mold. The third preheating process in S119 is a 100° C. preheating process and lasts 10 minutes. The third preheating process makes the insulating layers and the conducting layer have a specified strength so that they will not cracked during the solidifying process in S121. The burning process takes place at 400° C. and lasts 30 minutes.

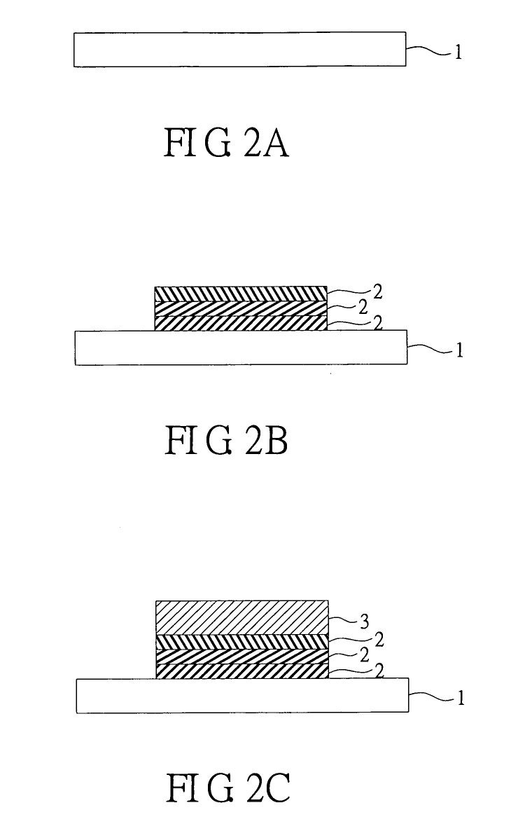

Reference is made to FIGS. 2A˜2F and 1. FIGS. 2A˜2F show perspective views of the manufacturing method for a straddling and supporting structure for the field emission display device of the present invention. The manufacturing method for a straddling and supporting structure of the present invention includes providing a substrate 1 (as shown in FIG. 2A). Next, an insulating layer 2 is formed on the substrate 1 via a printing method, a surface of the insulating layer 2 is preheated via a first preheating process, a second insulating layer is stacked on the insulating layer via the printing method, a surface of the second insulating layer 2 is preheated via the first preheating process, and the above steps are repeated until a plurality of insulating layers 2 are formed on the substrate 1. In this embodiment, there are three insulating layers (as shown in FIG. 2B). Next, a conducting layer 3 is stacked on the last insulating layer 2 via the printing method (as shown in FIG. 2C). A surface of the conducting layer 3 is preheated via a second preheating process, and a mold board 4 having a convex mold 41 is adopted to correspond with the conducting layer 3 (as shown in FIG. 2D). A concave groove 31 is formed on the surface of the conducting layer 3 via a mold-pressing method (as shown in FIGS. 2E and 2F). The insulating layers 2 and the conducting layer 3 are preheated via a third preheating process. Finally, the insulating layers 2 and the conducting layer 3 are solidified via a burning process.

The first preheating process is a 100° C. preheating process and lasts 10 minutes. The first preheating process removes part of the printing material liquid of the insulating layer and solidifies the printing material of the insulating layer to support the upcoming printing process. The second preheating process is a 100° C. preheating process and lasts 2 minutes. The second preheating process removes part of the liquid on the surface of the printing material and makes the conducting layer 3 more malleable for being processed in the mold-pressing process. The thickness of the convex mold 41 is 10˜15 μm. The depth of the concave groove 31 of the conducting layer 3 corresponds to the thickness of the convex mold 41. The third preheating process is a 100° C. preheating process and lasts 10 minutes. The third preheating process makes the insulating layers 2 and the conducting layer 3 have a specified strength so that they will not crack during the burning process. After the straddling and supporting structure has been processed by the third preheating process and the high temperature burning process, the straddling and supporting structure is solidified. The high temperature burning process is a 400° C. burning process and lasts 30 minutes.

The thickness of the stacked insulating layers 2 is 50 μm, and the thickness of the conducting layer is 25˜30 μm. The printing material of the conducting layer 3 is the same as that of the electrode conducting lines. Both are made of silver glue printing material having glass powder. The preferred pressure pressing on the conducting layer 3 by the mold board 4 is 0.75 Kg/cm². The mold board 4 is made of a rigid material so that the mold board 4 is not deformed when the mold board 4 is pressed on the conducting layer 3.

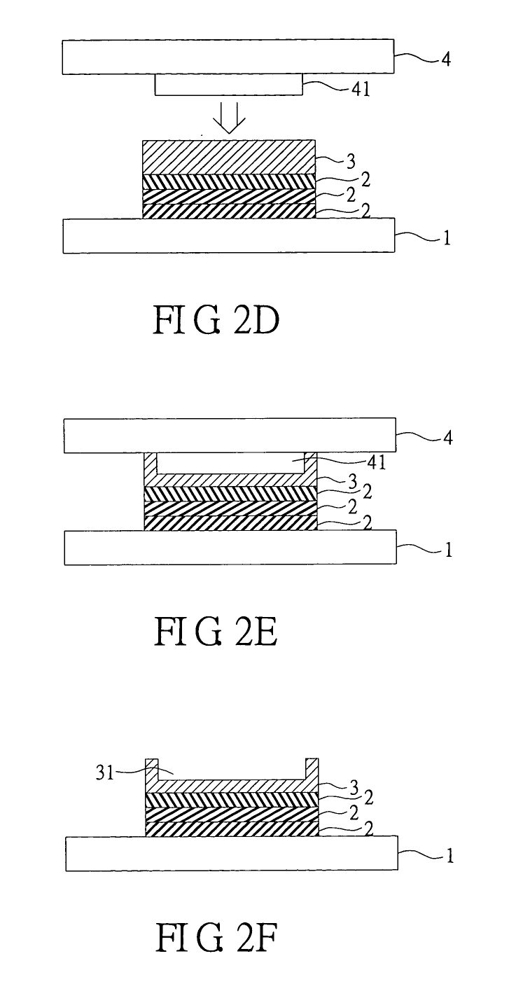

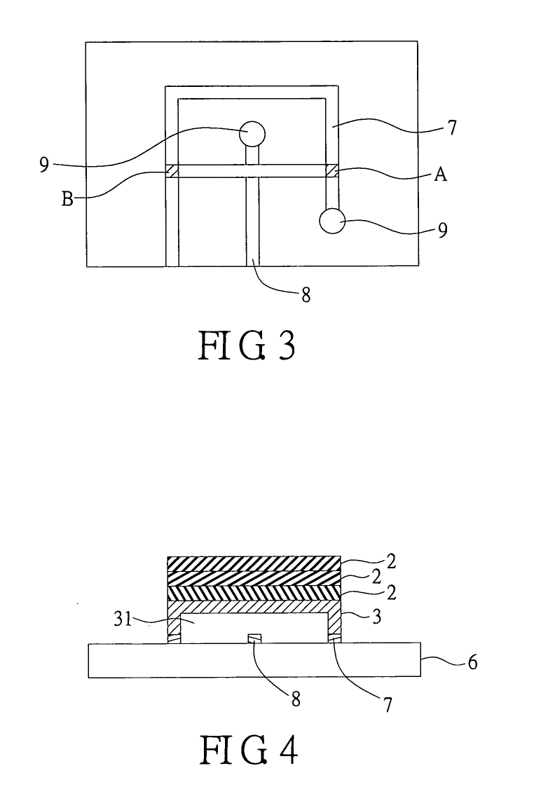

Reference is made to FIGS. 3 and 4, which show the first embodiment of the straddling and supporting structure for the field emission display device of the present invention. The straddling and supporting structure includes a plurality of insulating layers 2, and a conducting layer 3. The insulating layers 2 are stacked, and the conducting layer 3 is located on one surface of the last insulating layer 2 of the insulating layers 2 and there is a concave groove 31 on a surface of the conducting layer 3. The conducting layer 3 is located on an anode substrate 6. In this embodiment, the anode substrate 6 has an independent conducting circuit 7, a second independent conducting circuit 8, and two lighting units 9 (alternatively, the anode substrate 6 has a plurality of conducting circuits, and a plurality of lighting units 9). The two conducting circuits are individually connected with the two lighting units 9. The conducting layer 3 is straddled to the first end A and the second end B of the independent conducting circuit 7 of the anode substrate 6 via the two ends of the concave groove 31. Thereby, the independent conducting circuit 7 conducts to the lighting unit 9 with a shortest conducting path via the conducting layer 3 straddling cross the first end A and the second end B. At the same time, a second independent conducting circuit 8 passes through the concave groove 31 so that path disposition of the independent conducting circuit 8 is not disturbed by the second conducting circuit.

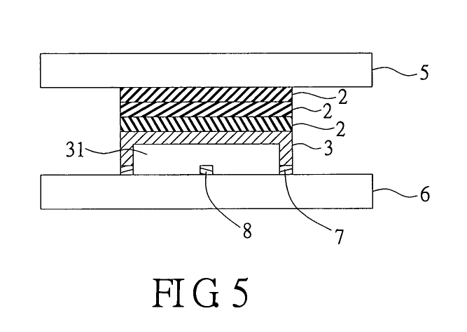

Reference is made to FIGS. 5 and 3. The straddling and supporting structure is applied to the cathode substrate 5 and the anode substrate 6 of the field emission structure. The straddling and supporting structure is used as a supporting structure and also forms a vacuum gap. The anode substrate 6 has a plurality of independent conducting circuits (in this embodiment, there is an independent conducting circuit 7 and a second independent conducting circuit 8). The straddling and supporting structure is jointed and packaged between the cathode substrate 5 and the anode substrate 6. One insulating layer 2 of the insulating layers 2 is located on the cathode substrate 5. The conducting layer 3 located on the last insulating layer 2 is installed on the anode substrate 6, and is electrically connected with the first end A of the independent conducting circuit 7 via one end of the concave groove 31 of the conducting layer 3. A second end of the concave groove 31 of the conducting layer 3 crosses over a second independent conducting circuit 8 and is electrically connected with the second end B of the independent conducting circuit 7. Thereby, a shorted conducting path for electrically connecting with the lighting unit 9 is achieved. The lighting unit 9 achieves a conducting effect via the wound wire of the independent conducting circuit 7, and also achieves a second conducting effect via the concave groove 31 of the conducting layer 3 of the straddling and supporting structure. When the original wound wire of the independent conducting circuit 7 is destroyed, the straddling and supporting structure provides a second conducting effect so that the lighting unit 9 still can light.

Because the concave groove 31 of the conducting layer 3 has a receiving function, a second independent conducting circuit 8 can pass through the concave groove 31 so that the problem of the independent conducting circuit 8 being disturbed and opening is avoided. By the same principle, a second independent conducting circuit 8 achieves the shortest conducting path via the concave groove 31 of the conducting layer 3.

The straddling and supporting structure for the field emission display device is located between the cathode substrate 5 and the anode substrate 6. The present invention has the following characteristics:

1. The thickness of the electrode structure is uniform and smooth, and the gap will not become smaller.

2. By disposing the straddling and supporting structure, the cathode substrate and the anode substrate maintain a fixed gap, and the electrode conducting line between the cathode and the anode achieves the shortest conducting path.

3. The electrode conducting line structure located between the cathode and the anode is uniform and stable, the conducting circuit is stable and has an improved effect.

4. The thickness of the vacuum gap between the cathode and the anode does not become larger.

5. A second conducting effect is achieved via the concave groove 31 of the conducting layer 3. When the original wound wire of the independent conducting circuit 7 is destroyed, the straddling and supporting structure provides a second conducting effect so that the lighting unit 9 can still light.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A manufacturing method of a straddling and supporting structure for the field emission display device, comprising:
(a) providing a substrate;
(b) forming an insulating layer on the substrate via a printing method;
(c) preheating a surface of the insulating layer via a first preheating process;
(d) stacking a second insulating layer on the insulating layer via the printing method;
(e) preheating a surface of the second insulating layer via the first preheating process;
(f) repeating steps (d) and (e) until a plurality of insulating layers are formed on the substrate;
(g) stacking a conducting layer on the last insulating layer via the printing method;
(h) preheating a surface of the conducting layer via a second preheating process;
(i) forming a concave groove on the surface of the conducting layer via a mold-pressing method;
(j) preheating the insulating layers and the conducting layer via a third preheating process; and
(k) solidifying the insulating layers and the conducting layer via a burning process.

2. The manufacturing method of a straddling and supporting structure for the field emission display device as claimed in claim 1, wherein the first preheating process of steps (c) and (e) is a 100° C. preheating process that lasts 10 minutes.

3. The manufacturing method of a straddling and supporting structure for the field emission display device as claimed in claim 1, wherein the second preheating process of step (h) is a 100° C. preheating process that lasts 2 minutes.

4. The manufacturing method of a straddling and supporting structure for the field emission display device as claimed in claim 1, wherein the thickness of the plurality of insulating layers is 50 μm.

5. The manufacturing method of a straddling and supporting structure for the field emission display device as claimed in claim 1, wherein the thickness of the conducting layer is 25˜30 μm.

6. The manufacturing method of a straddling and supporting structure for the field emission display device as claimed in claim 1, wherein the printing material of the conducting layer is a silver glue printing material that includes glass powder.

7. The manufacturing method of a straddling and supporting structure for the field emission display device as claimed in claim 1, wherein the mold-pressing at step of (i) utilizes a mold board corresponding to the conducting layer to press the surface of the conducting layer.

8. The manufacturing method of a straddling and supporting structure for the field emission display device as claimed in claim 7, wherein the pressing force upon the surface of the conducting layer from the mold board is 0.75 Kg/cm².

9. The manufacturing method of a straddling and supporting structure for the field emission display device as claimed in claim 7, wherein the mold board has a convex mold for forming the concave groove.

10. The manufacturing method of a straddling and supporting structure for the field emission display device as claimed in claim 9, wherein the thickness of the convex mold is 10˜15 μm.

11. The manufacturing method of a straddling and supporting structure for the field emission display device as claimed in claim 10, wherein the depth of the concave groove corresponds to the thickness of the convex mold.

12. The manufacturing method of a straddling and supporting structure for the field emission display device as claimed in claim 1, wherein the third preheating process of step (j) is a 100° C. preheating process that lasts 10 minutes.

13. The manufacturing method of a straddling and supporting structure for the field emission display device as claimed in claim 1, wherein the burning process of step (k) is a 400° C. burning process that lasts 30 minutes.

14. A straddling and supporting structure for the field emission display device, comprising:
a plurality of insulating layers, wherein the insulating layers are stacked; and
a conducting layer located on one surface of the last insulating layer of the insulating layers, wherein there is a concave groove on a surface of the conducting layer.

15. The straddling and supporting structure for the field emission display device as claimed in claim 14, wherein the thickness of the plurality of insulating layers is 50 μm.

16. The straddling and supporting structure for the field emission display device as claimed in claim 14, wherein the thickness of the conducting layer is between 25˜30 μm.

17. The straddling and supporting structure for the field emission display device as claimed in claim 14, wherein the conducting layer comprises of a silver glue printing material that includes glass powder.

18. The straddling and supporting structure for the field emission display device as claimed in claim 14, wherein the depth of the concave groove is between 10˜15 μm.
